(19) United States
(12) Patent Application Publication
(10) Pub. No.: US 2021/0285631 A1
(43) Pub. Date: Sep. 16, 2021

(54) Q.I. Pocket with LED lighting

(71) Applicant: Sean Morales, San Antonio, TX (US)

(72) Inventor: Sean Morales, San Antonio, TX (US)

(21) Appl. No.: 16/819,122

(22) Filed: Mar. 15, 2020

(51) Int. Cl. F21V 33/00; F21V 23/04; H02J 7/00

(52) U.S. Cl. CPC F21V 33/0008; F21Y 2115/10; H02J 7/0045; F21V 23/04

(57) ABSTRACT

A wireless pocket transmitter with integrated LED light tool, comprising a two-pocket system used to charge phones, tablets, watches and any device that uses wireless charging technology, a LED lighting tool for searching dark compartments and a selector for light intensity and color, the wireless pocket transmitter with integrated LED light tool has the advantages of being installed onto any wearable accessory and the ease of use will make it far more convenient than stationary or wired charging methods.

### SIMPLIFIED DESCRIPTION OF DRAWINGS

FIG. 1: Shows how a compatible electronic device will look when placed into the Wireless pocket transmitter.

FIG. 2: The individual components and make-up of the Wireless pocket transmitter.

FIG. 3: Shows the location of the LED lighting tool.

FIG. 4: A close up view of the LED lights.

FIG. 5: Wring example.

### DETAILED DESCRIPTION OF DRAWING

The Images on the specification art Dace have numbers and letters that directly correspond to those found on this page.

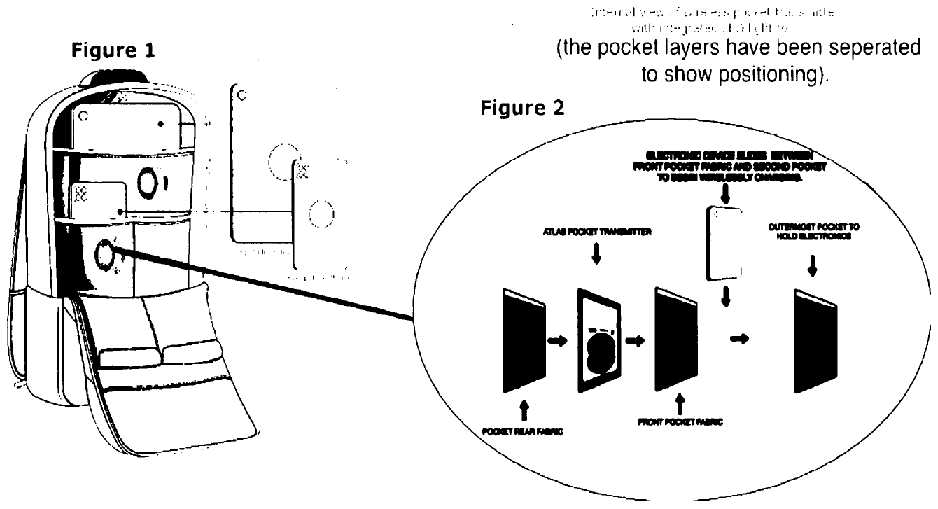

FIG. 1—Is an example of several wireless pocket transmitters with an integrated LED light tool placed in a single backpack. The image in FIG. 1 shows how the pocket will look when it has been attached to a backpack (superficial view). This would be the same if it were in a purse, blazer. or briefcase. The image also demonstrates how a compatible electronic device would fit into said pockets for wireless charging.

FIG. 2—This image is essentially deconstructing the wireless pocket transmitter with integrated LED light tool so that each layer can be observed. The wireless pocket transmitter with integrated LED light tool will be placed between a plurality of fabrics.

(A) This image is of the rear square piece of material (at the back of the pocket). This material may provide protection from cleaning and weather.

(B) This image is of the wireless pocket transmitter with integrated LED light tool. B (The wireless pocket transmitter with integrated LED light tool) will rest on A (The material backing of the pocket).

(C) This image is showing the next square piece of material that will go over the wireless pocket transmitter with integrated LED light tool (B). The two square pieces of material (A and C) will then be sewn or connected together. encapsulating the transmitter between them. A small opening will be made at the bottom of the pocket created by A and C for a power cable to pass through.

(D)This image is of a compatible electronic device. It is meant to demonstrate where the compatible device will be placed for charging (Between C and D).

(E) This image shows the Positioning of the outermost square piece of material. This outermost square will be sewn or connected onto the previous two (A and C) while leaving room for a compatible device to slide between the C and E layers of material. The outermost piece of material (E) will be connected on the right left and bottom only. The top will be left open for storage (the opening where D slides between C and E).

Once a phone, tablet, computer, or plurality of electronic devices that utilize wireless charging technology are placed inside the open pocket/sleeve, the wireless pocket transmitter with integrated LED light tool will instantly begin charging the device. The wireless pocket transmitter with integrated LED light tool will have on and off buttons. switches and or wireless controls to manually work the transmitter and LED light.

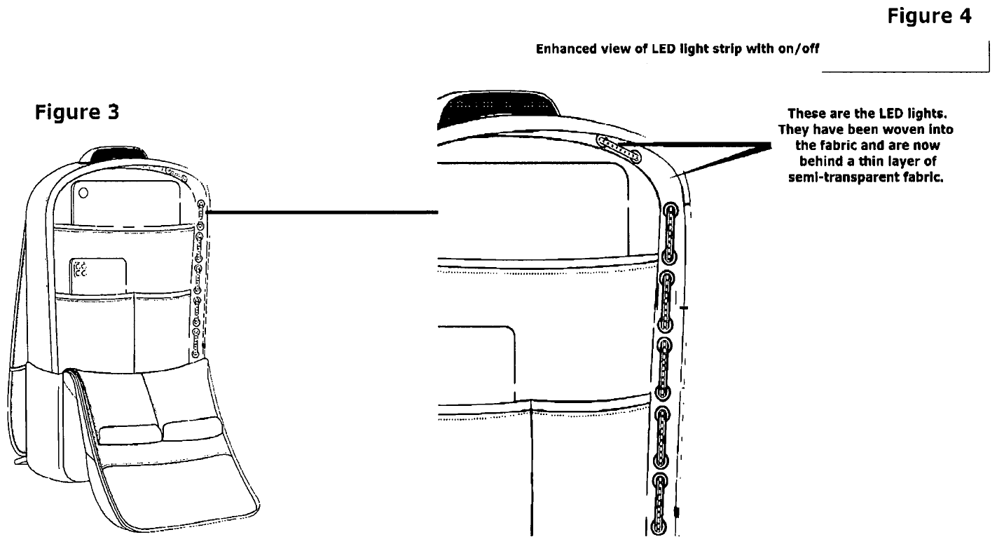

FIG. 3: In this example (a backpack). it goes around the rim.

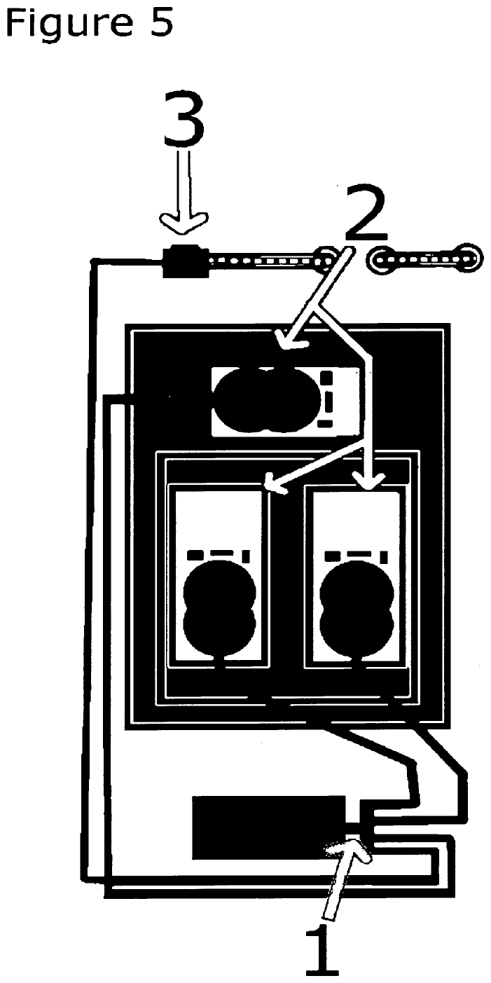

FIG. 4: A close up view of the LED lights. Demonstrates how the LED light tool weaves in and out of the fabric/material,

FIG. 5—Shows an example of how the wiring (1) that provides power to the wireless pocket transmitter (2) and LED light tool with on off switch (3) will connect to a power source. Connection types may include USB, Micro USB and so on.

1-5. (canceled)

6. The wireless pocket transmitter with integrated LED light is a device for charging electronics wirelessly through compartments within wearable accessories and a LED lighting tool for easy viewing in dark compartments, comprising: A transmitter housed between two pieces of waterproof material and an outer pocket that is used as housing while wirelessly charging a plurality of independent compatible devices; A wire that will connect both the LED lighting tool and wireless pocket transmitter to a rechargeable power source; A LED strip with a plurality of lighting options; a unit to control LED lighting tool.)

7. The wireless pocket transmitter with integrated LED light according to claim 6, Wherein the wirelessly charged compatible independent electronic devices, eg: tablets, phones or any device containing wireless receivers.)

8. The wireless pocket transmitter with integrated LED light according to claim 6, Wherein the wireless transmitter will be housed within pockets of layered material; the lowest layer of material (layer 1) will be set; the transmitter (layer 2) will then go over previous layer (layer 1); the next layer (layer 3) will be placed above the transmitter (Layer 2) encapsulating the transmitter between layers 1 and 3; layers 1 and 3 will be connected on all four sides (a small hole will be made in the bottom of this pocket for the power wire that goes to the transmitter); a fourth layer will be connected onto the now combined layers of 1, 2 and 3; the fourth pocket will be connected on all sides except the top, leaving it open to be used as a pocket for charging compatible devices.)

9. The wireless pocket transmitter with integrated LED light according to claim 6, Wherein the rechargeable battery can be any compatible portable battery with a USB connector.)

10. The wireless pocket transmitter with integrated LED light according to claim 6, Wherein the LED lighting tool is a lighting device used to bring clarity to darkened compartments in wearable accessories,)

11. The wireless pocket transmitter with integrated LED light according to claim 6, Wherein a unit to control LED lighting tool will be in the form of a manual on off switch/ button.
